(19) United States
(12) Patent Application Publication
(10) Pub. No.: US 2020/0341776 A1
(43) Pub. Date: Oct. 29, 2020

(54) APPARATUS FOR INITIALIZING MEMORY USING A HARDWARE ENGINE FOR MINIMIZING BOOT TIME

(71) Applicants: Krishnaprasad H, Bangalore (IN); Ramkumar Jayaraman, Bangalore (IN); Jorge Serratos Hernandez, Cedar Park, TX (US)

(72) Inventors: Krishnaprasad H, Bangalore (IN); Ramkumar Jayaraman, Bangalore (IN); Jorge Serratos Hernandez, Cedar Park, TX (US)

(21) Appl. No.: 16/922,942

(22) Filed: Jul. 7, 2020

(51) Int. Cl. G06F 9/4401; G06F 12/06; G06F 9/445

(52) U.S. Cl. CPC G06F 9/4403; G06F 2212/1016; G06F 9/44557; G06F 12/0646

(57) ABSTRACT

Methods and apparatus for initializing memory using a hardware engine for minimizing boot time. Booting of firmware in a computer system including one or more memory devices and a processor System on a Chip (SoC) including a central processing unit (CPU) having a plurality of cores and a memory controller coupled to the one or more memory devices is initialized. In parallel with at least a portion of booting the firmware, a plurality of memory ranges in at least one memory devices is initialized using at least one scrub engine. The at least one scrub engine may be embedded in the memory controller or external to the memory controller. Memory devices and ranges within those devices may continue to be initialized in parallel with booting an operating system following firmware booting. The scrub engine includes one or more registers or embedded memory used to program/store descriptor chains describing memory ranges to be initialized.

### BACKGROUND INFORMATION

Fast boot is an important feature for computing systems. This becomes even more important on segments like embedded appliances, advanced driver-assisted systems (ADAS), telecom base stations, etc. For example, autonomous driving systems or driving systems with automated driver assistance mechanisms may require a boot-up process to be sufficiently complete such that a corresponding application may be initiated within a predetermined duration following initiating a system boot operation.

Fast booting becomes a challenge on systems that have high memory capacity due to the need to have the memory initialized before it can be used. For example, DRAM (Dynamic Random Access Memory) memories with ECC (Error Correction Code) require scrubbing to ensure the DRAM data bits and corresponding ECC bits are in a known state before the memory is accessed for use. Scrubbing this memory consumes a significant portion of total available boot budget.

To provide some context, measurements using current processors indicate that it takes about 500 milliseconds (ms) to scrub 4 GB (Gigabytes) of DDR4 (Double Data-Rate version 4) memory, which will be higher for larger amounts of DRAM memory. The total available boot budget required by some automotive OEMs/customers is about 2000 ms. This means scrubbing or initializing the memory consumes about 25% of the total available budget. Thus, it becomes difficult to achieve these aggressive boot time targets for these new automotive applications such as ADAS.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram of a computer system configured to implement one or more patrol scrub engines for initializing memory, according to one embodiment;

FIG. 1a is a schematic diagram of a computer system configured to implement one or more demand scrub engines for initializing memory, according to one embodiment;

FIG. 1b is a schematic diagram of a computer system including multiple memory controllers configured to implement one or more hardware engines for initializing memory, according to one embodiment;

FIG. 2a is a schematic diagram of a memory sub-system including a memory controller having up to four channels, each coupled to three DIMMs, according to one embodiment;

FIG. 2b is a diagram illustrating implementation of descriptor chains for each of the DIMMs connected to the first memory channel in FIG. 2a;

FIG. 3 is flowchart illustrating operations and logic for implementing memory initialization using one or more hardware engines, according to one embodiment;

FIG. 4 is a schematic diagram illustrating an overview of a multi-tier memory scheme, according to one embodiment;

FIG. 5 is a diagram illustrating one embodiment of a multi-tier memory architecture under which near memory is accessed locally, and far memory includes both local memory devices and storage class memory (SCM) accessed over a low latency fabric; andand

FIG. 6 is a schematic diagram of a system in which embodiments herein may be implemented.

### DETAILED DESCRIPTION

Embodiments of methods and apparatus for initializing memory using a hardware engine for minimizing boot time are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

In accordance with aspects of embodiment disclosed herein, memory scrubbing is broken into phases and dispatched in different modes. In some embodiments, a modified version of an existing IP (intellectual property) engine that exists on some current processors is employed to scrub the memory in the background and expose the memory to an operating system as the memory initialization is complete and is ready for normal use. The operations for this solution include:
1. DRAM Memory regions are divided into (A) Bare minimum amount that must be scrubbed at firmware boot; and (B) Quantity of memory that can be scrubbed post-boot during operating system boot and OS runtime;
2. Implement hardware IP to configure ranges that are to be scrubbed and trigger completion events to interrupt the OS to inform of the new usable memory; and
3. Re-use an existing logical memory hot-add feature in the OS to add to the OS memory pool.

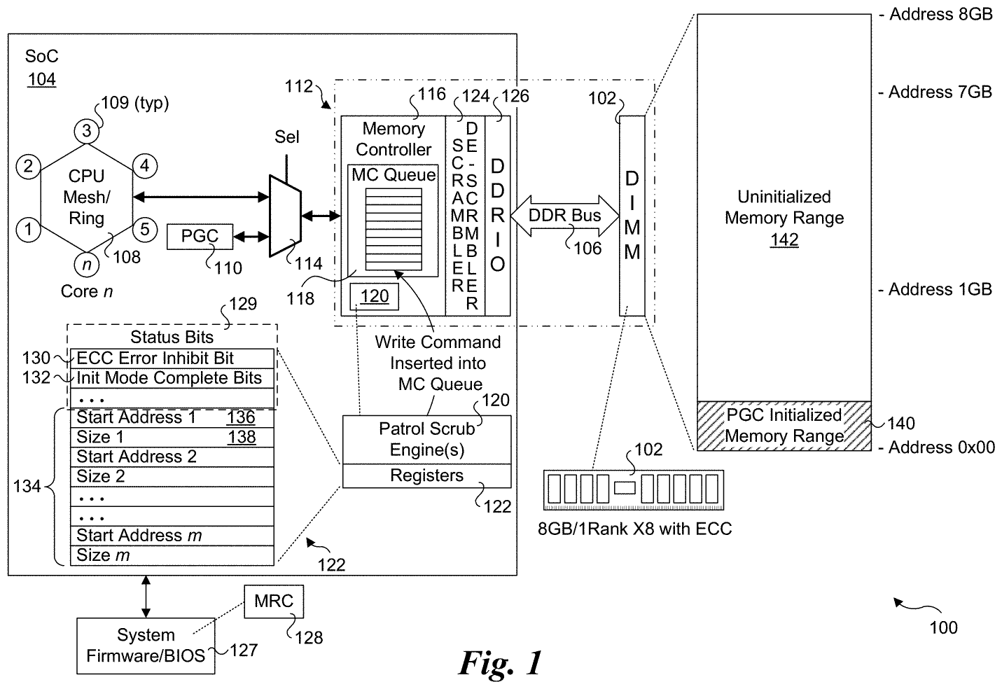

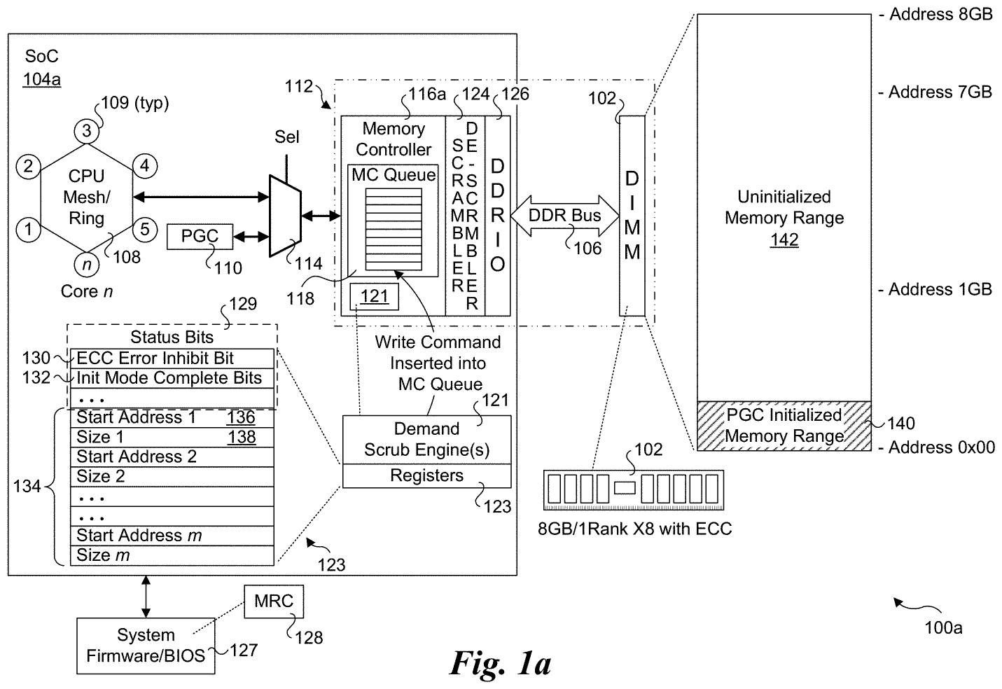

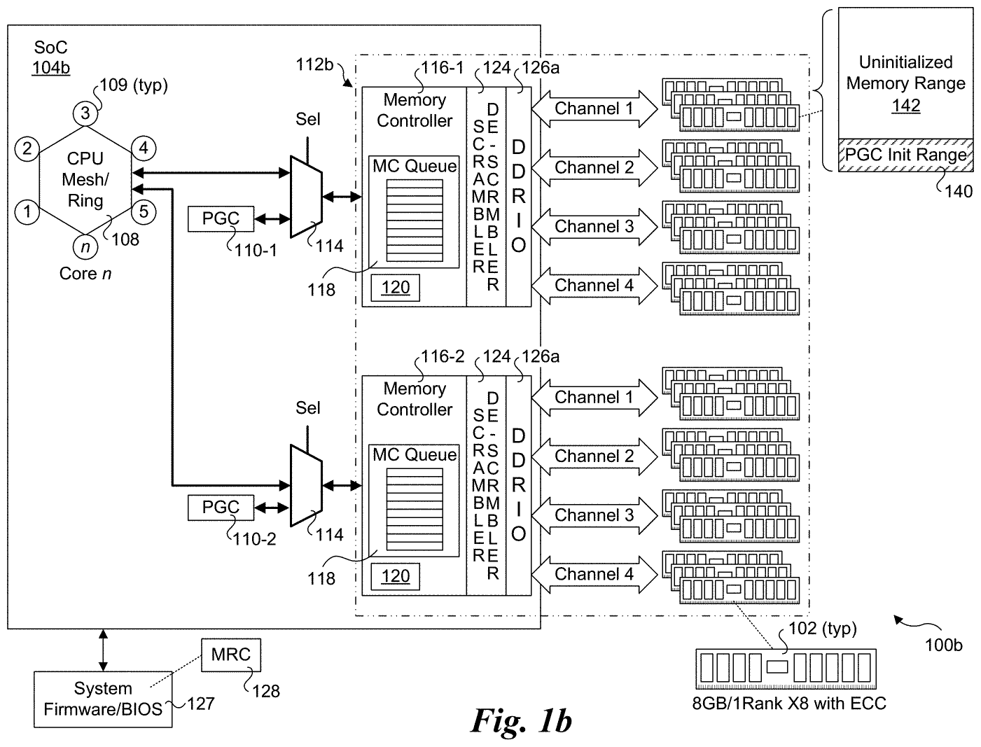

FIG. 1 shows an exemplary implementation of the solution for a computing system 100 with a single rank x8, 8 GB, ECC DIMM (Dual Inline Memory Module) 102 connected to a processor System on a Chip (SoC) 104 via a DDR bus 106. Processor SoC 104 includes a central processing unit 108 with n cores 109 connected with a ring or mesh architecture. Processor SoC 104 further includes Pattern Generator and Checker (PGC) engines 110 connected to a memory sub-system 112 via a multiplexer 114. Memory sub-system 112 includes a memory controller (MC) 116 having an MC queue 118 and one or more patrol scrub engines 120 having programmable registers 122, a scrambler de-scrambler 124 and a DDR Input Output (DDR IO) physical layer (PHY) 126. Processor SoC 104 is connected to a firmware storage device 127 that stores the system firmware and BIOS including memory reference code (MRC) 128. More generally, as used herein, firmware includes UEFI (Universal Extensible Firmware Interface) firmware and firmware-based boot loaders.

PGC engines 110 are hardware-based pattern generators that can be programmed to write/read the DDR memories with a specified pattern/data. The memory traffic path from cores 109 to DIMM 102 is mutually exclusive with the memory traffic path from PGC engines 110 to DIMM 102. A patrol scrub engine 120 is a hardware-based engine that performs periodic memory scrub operation during a system's run-time to correct silent data corruption. This involves periodically reading a DRAM address, checking the ECC data, correcting any memory errors (if any and if possible) and write the corrected values back. Under embodiments herein, one or more patrol scrub engines 120 are further used to perform memory scrub operations during system boot and OS runtime, as described in further detail below.

In a current approach, MRC 128, which is executed as part of system firmware (or BIOS, UEFI firmware, boot loader firmware, etc.), programs PGC engines 110 to scrub the DRAM memories. In one embodiment, there is one PGC per memory channel and there could be up to 4 memory channels per memory controller. At the end of MRC, the MRC program individual PGC engines to scrub the memory behind its channel. While the PGC engines scrub the memory, the core is blocked on a tight-loop, checking whether the memory scrub action is completed by the PGC. To give an example, for initializing 4 GB of memory under this current approach, the PGC takes around 500 ms to program and scrub the memory, impacting the system's boot time. For larger amounts of memory, the impact is proportionally greater. After the entire memory is initialized, the system firmware relocates itself from the Cache as RAM (CAR) memories to DRAM based main memory proceeding to operating system (OS) boot.

Under the embodiment of FIG. 1, patrol scrub engines 120 are enhanced to perform memory initialization (for uninitialized memory) in parallel with the system firmware/OS boot process. Existing patrol scrub engines are employed to periodically scrub the system memory based on a default or user specified interval. To enhance the patrol scrub engines to perform memory initialization, new programmable registers 122 are added to a patrol scrub engine 120.

Under other embodiments, another hardware engine present in a memory controller, such as demand scrub engine, may be used in place of one or more patrol scrub engines. An exemplary use of a demand scrub engine is illustrated by a computing system 100a in FIG. 1a, which includes a memory controller 116a including one or more demand scrub engines 121 and programmable registers 123. Unlike PGC, demand scrub engine and patrol scrub engine can execute memory traffic in parallel to core traffic to memory. This means that both memory initialization and the OS boot can be performed in parallel.

This approach provides the full availability of the compute and memory resources within a few milliseconds of OS boot. Also, no special software or software customizations such as kernel drivers and/or bootloader changes or third-party dependencies are required for this solution. Thus, this solution is OS/software agnostic and is hardware-based functionality that is implemented in silicon (e.g., as embedded circuitry and/or one or more IP blocks on an SoC).

One embodiment of new programmable registers 122 are shown in FIG. 1. For simplicity, the term “registers” is used in the following discussion. More generally, programmable registers 122 represent any means for storing the data structures described herein, including registers having the same or variable sizes, as well as one or more blocks of memory embedded on a memory controller (or otherwise included in a memory controller IP block on an SoC).

Programmable registers 122 include a set of status bits 129 comprising an ECC error inhibit bit 130, init mode completion bits 132, and other status bits (depicted by ellipses . . . ). Following status bits 129 is a chain of descriptors 134 having a format {Start Address 136, Size 138}, where the start address defines a start address on the DIMM and size defines the size of a memory range to be initialized. Alternatively, a descriptor may have a format {Start Address, Size, Add indicator}, where the Add indicator is used to indicate whether the correspond memory range should be added to information describing available memory published to the operating system as soon as that memory range has been initialized. Generally, the number of descriptors depends on the system design. In the illustrated example there are m descriptors for DIMM 102. As described below, for systems with multiple DIMMs there may be a respective set of descriptors for each DIMM. In one embodiment, at least four descriptors are used per DIMM.

Generally, the individual parts of a descriptor, such as {Start Address}, {Size}, (optional) {Add indicator} may be written to individual registers (as illustrated in the Figures herein) or in a single register having a delimiter between the descriptor components, such as a comma, a space, a semi-colon, a pipe symbol, or any other delimiter. Similarly, descriptors may be written to a data structure in memory using an array or list or the like, such as using a linked-list.

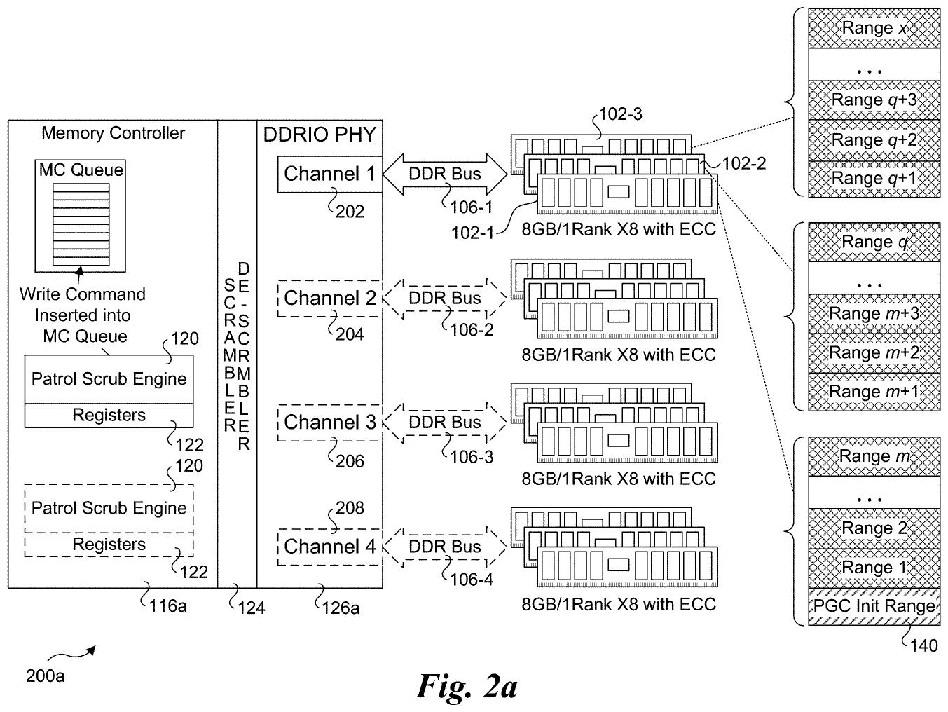

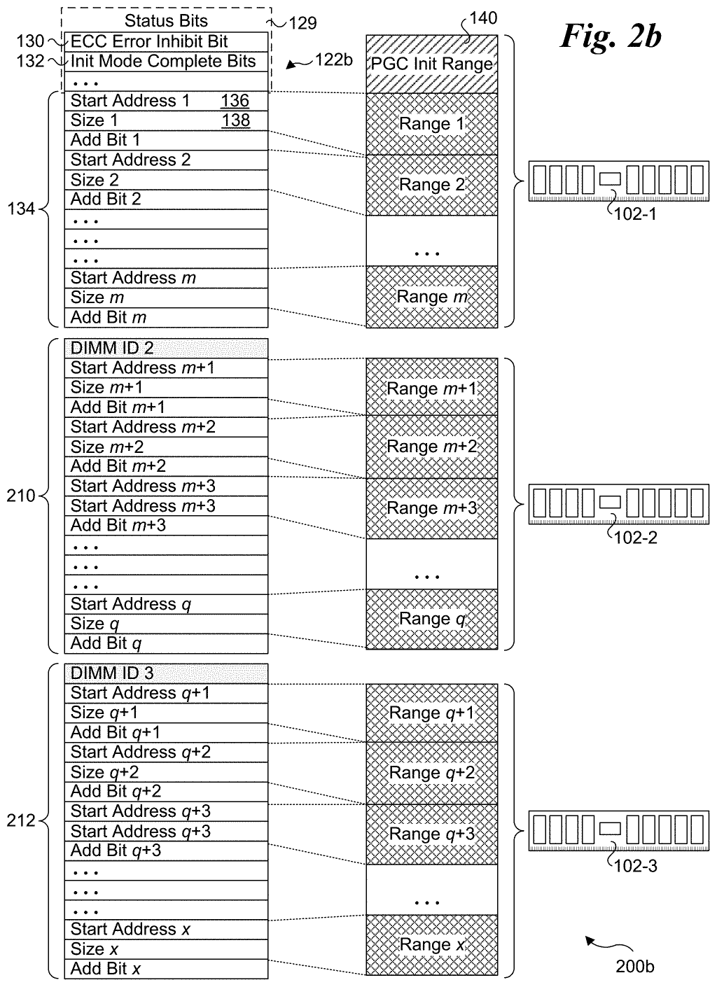

FIGS. 2a and 2b respectively show diagrams 200a and 200b illustrating aspects of a memory sub-system employing multiple channels and multiple DIMMs per channel. In some embodiments, a memory control may have up to four memory channels, where each channel has a respective set of signals depicted herein as a DDR bus, noting DDR here is generic (i.e., may apply to any DDR-based standard). Under some current DDR standards, a single memory channel may be used to communicate with up to three DIMMs. Future memory controllers may support more memory channels (e.g., 6 or 8), and future memory channels may support connection to more than three DIMMS.

As shown in diagram 200a of FIG. 2a, the memory subsystem includes a memory controller 116a having one or more patrol scrub engines 120 (components shown in dashed outline are optional), each with a set of registers 122. DDRIO PHY 126a includes up to four memory channels 202, 204, 206, and 208 (also labeled and referred to as Channel 1, Channel 2, Channel 3, and Channel 4). Each channel is connected to a respective DDR bus 106, depicted as DDR buses 106-1, 106-2, 106-3, and 106-4. Each of these DDR buses is connected to three DIMMs 102. For example, DDR bus 106-1 is connected to DIMMs 102-1, 102-2, and 102-3.

During boot operations, memory ranges in DIMMs 102-1, 102-2, and 102-3 will be initialized in accordance with corresponding range descriptors, such as illustrated by registers 122b in FIG. 2b. The first DIMM (102-1) is used for firmware booting, and thus includes PGC initialized memory range 140. In the example shown in FIGS. 2a and 2b the entirety of the memory address space of DIMMs 102-1, 102-2, and 102-3 is initialized. However, this is merely an example, as in an actual implementation the may be portions of the memory space for a DIMM that are not initialized.

As shown in FIG. 2b, a DIMM identifier (ID) is included at to start of each descriptor chains 210 and 212 corresponding to DIMMs 102-2 and 102-3. Alternatively, some form of delimiter may serve a similar purpose (e.g., used to separate the descriptor chains for respective DIMMs).

Returning to FIG. 2a, for a given memory controller there may be a single data structure used for all the descriptor chains or there may be separate data structures, such as a respective data structure for each channel. Under embodiments employing multiple patrol scrub engines 120, each patrol scrub engine will generally have a separate set of registers 122, as shown in FIG. 2a. In some embodiments employing multiple patrol scrub engines, a given patrol scrub engine may be used to initialize memory coupled to one or more channels. For example, there could be a 1:1 or 1:2 relationship between patrol scrub engines and memory channels.

Some processor SoC may include two or more memory controllers having a similar configuration to the memory controllers illustrated herein. For example, compute system 110b in FIG. 1b includes a processor SoC 104b including a memory sub-system 112b including two memory controller 116-1 and 116-2, each including a DDRIO PHY 126a similar to that shown in FIG. 2a. In the illustrated embodiment, each memory controller 116-1 and 116-2 is coupled to a respective multiplexer 114-1 and 114-2 and a respective PGC 110-1 and 110-2. In another embodiment (not shown), a single PCG is used for both memory controllers 116-1 and 116-2.

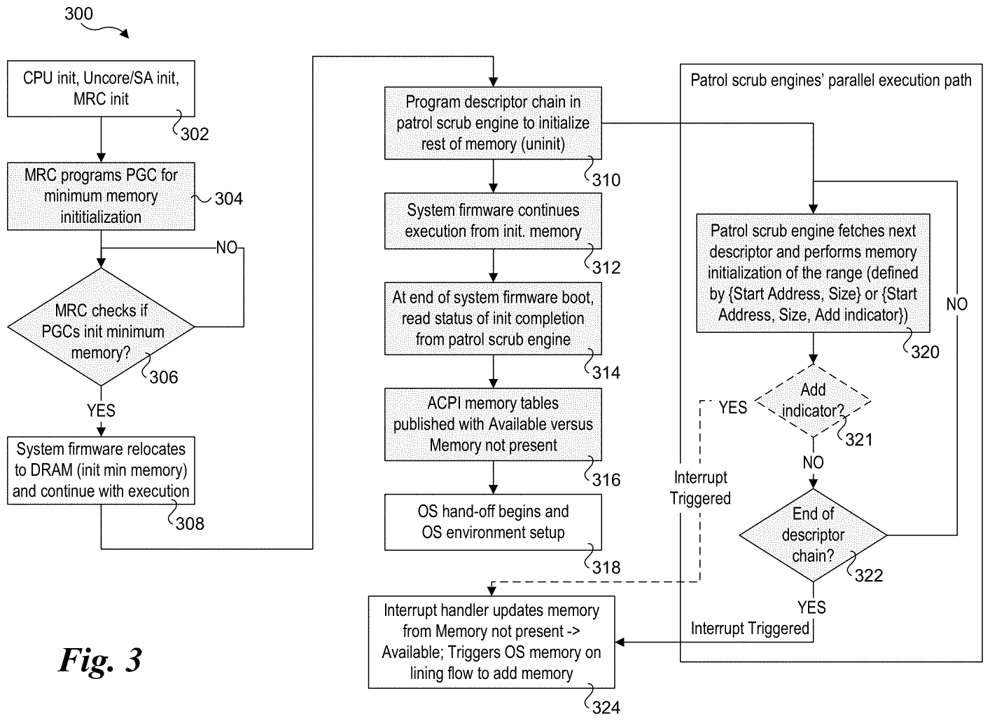

FIG. 3 shows a flowchart 300 illustrating operations and logic performed during a system boot process, according to one embodiment. Blocks depicted with a gray background are new operations, while block depicted with white background are existing operations. In a block 302, the CPU unit, uncore/SA (system agent) unit, and MRC are initialized. Following MRC initialization, the MRC programs the PGC engines to initialize a minimal size of memory (programmable by user), as shown in a block 304. The amount of memory to be initialized is generally in the range of few MB, as required for the next stage of system firmware boot. As shown in a decision block 306 that loops back to itself, the MRC checks to determine if the PGCs have completed initializing the minimum amount of memory. After the PGC engine completes the memory initialization of this minimal memory, the system firmware is relocated to DRAM and the system proceeds to boot from the DRAM.

The result of the foregoing operations is shown in FIGS. 1 and 1a as PGC initialized memory range 140 with the remaining portion of the memory address space depicted as uninitialized memory range 142. It is noted that the address markings in FIGS. 1 and 1a are not to scale.

Returning to FIG. 3 at a block 310, in parallel with booting of the firmware from the initialized minimum memory the MRC programs the descriptor chain in the patrol scrub engine to initialize the remaining uninitialized memory based on the number of descriptors available, as shown in a block 310. As the patrol scrub engine initializes the memory, the system firmware continues to execute from the previously initialized memory, as shown in a block 312. Toward the end of system firmware boot just before the hand-over to the bootloader/OS, the system firmware queries the patrol scrub engine for the number of descriptors completed in a block 314. Based on this, the range of memory available and usable in the system is evaluated (address range initialized by PGC engines+address range which patrol scrub engines have completed initialization). This address range is published via ACPI (Advanced Configuration and Power Interface) tables as ‘Available Memory’. The remaining range of memory that the patrol scrub engine is working on is published via ACPI tables as ‘Memory not present’. These operations are depicted in a block 316. In a block 318 the operating system hand-off begins, and the OS environment is set up.

The right-hand portion of flowchart 300 depicts operations performed in parallel by the patrol scrub engines. The patrol scrub engines will walk through the descriptor chain(s) to initialize associated ranges of memory. As shown in a block 320, the patrol scrub engine fetches a next descriptor in the descriptor chain and initializes a range of memory defined by the {Start Address, Size} or {Start Address, Size, Add indicator} descriptor values. As depicted by a decision block 322, the operations of block 320 will be performed for each descriptor in the chain until the end of the chain has been reaches.

As shown by a YES answer to decision block 322, after all the programmed descriptors are processed, an interrupt is triggered. As shown in a block 324, in response to the interrupt a corresponding interrupt handler that is part of the system firmware executes and triggers memory on lining flow (i.e., mark portions of memory that were marked as not present prior to initialization as available). This triggers the OS to re-evaluate the ACPI memory objects and adds the newly available memory pages for software's use. In one embodiment the interrupt is a system management interrupt (SMI) and the interrupt handler is an SMI hander that is executed in System Management Mode (SMM).

In embodiments in which an Add indicator is used, the Add indicator value tells the logic whether to add the memory range to the available memory in the ACPI memory tables when the memory is initialized, or to wait (for the memory range) until the descriptor chain has been completed. This extra logic is shown as an optional decision block 321, which will trigger an interrupt after a given memory range has been initialized in block 320 and the Add indicator value is set (e.g., ‘1’). Otherwise, if the Add indicator is cleared (e.g., ‘0’) the answer to decision block 321 will be no and the process will flow through to decision block 322. An interrupt triggered by decision block 321 will be handled in block 324 in a manner similar to that described above.

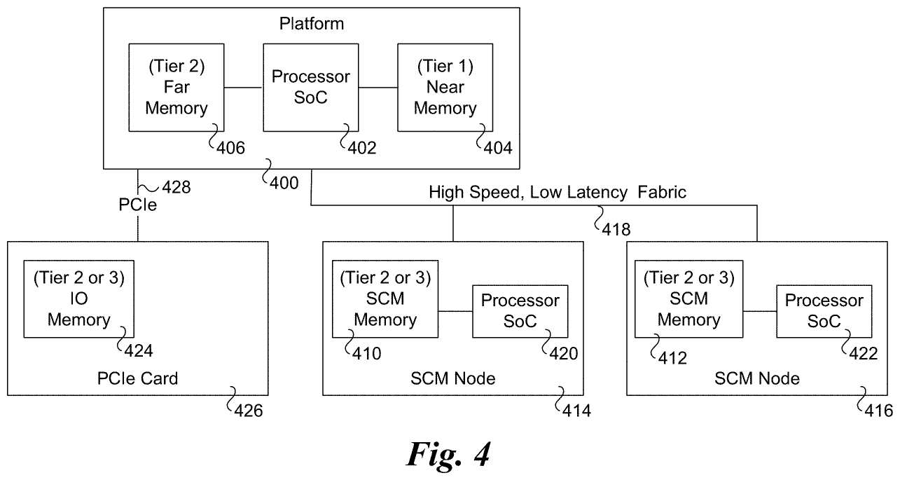

The teachings and the principles described herein may be implemented using various types of memory schemes, including tiered memory schemes. For example, FIG. 4 illustrates an abstract view of a tiered memory scheme employing three tiers: 1) “near” memory; 2) “far” memory; and 3) SCM (storage class memory). The terminology “near” and “far” memory do not refer to the physical distance between a processor SoC and the associated memory device, but rather the latency and/or bandwidth for accessing data stored in the memory device.

FIG. 4 shows a platform 400 including a processor SoC 402 coupled to near memory 404 and far memory 406. Compute node 400 is further connected to SCM memory 410 and 412 in SCM memory nodes 414 and 416 which are coupled to compute node 400 via a high speed, low latency fabric 418. In the illustrated embodiment, SCM memory 410 is coupled to a processor SoC 420 in SCM node 414 and SMC memory 412 is coupled to a processor SoC 422 in SCM node 416. FIG. 4 further shows a second or third tier of memory comprising IO (Input-Output) memory 424 implemented in a PCIe (Peripheral Component Interconnect Express) card 426 coupled to platform 400 via a PCIe link 428.

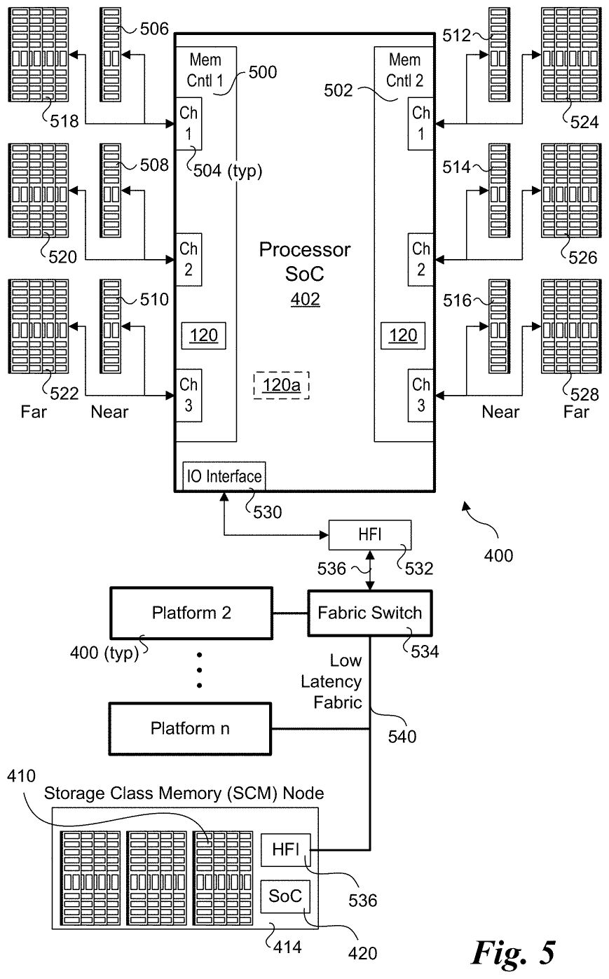

FIG. 5 show further details of one embodiment of platform 400. processor SoC 402 includes a pair of memory controller 500 and 502, each including three memory channels 504 (also labeled Ch(annel) 1, Ch 2, and Ch 3) and one or more patrol scrub engines 120. Optionally, processor SoC 402 may include one or more patrol scrub engines 120a that is external to memory controllers 500 and 502. Each of the memory channels 504 is coupled to a respective pair of memory devices, including a near memory device (memory devices 506, 508, 510, 512, 514, and 516) and a far memory device (memory devices 518, 520, 522, 524, 526, and 528). Processor SoC 402 further includes one or more input-output (TO) interfaces 530.

In the illustrated embodiment, IO interface 530 of processor SoC 402 is coupled to a host fabric interface) HFI 532, which in turn is connected to fabric switch 534 via a fabric link 536. An HFI 538 on an SCM node 538 is coupled to low latency fabric 540, as are one or more other platforms 400. In one embodiment, SCM memory 410 supports the NVMe (Non-volatile Memory express) protocol and is implemented using an NVMe over Fabric (NVMe-oF) protocol. Far SCM memory 410 may also be implemented using other types of non-volatile memory devices and protocols, such as DC Persistent Memory Module (DCPMM) devices and protocols.

In a manner similar to that shown in 1b, 2a, and 2b, memory ranges in memory devices (e.g., DIMMs) implemented for near and far memory coupled to the same memory channel may be initialized by one or more patrol scrub engines 120 in memory controllers 500 and 502 or patrol scrub engine 120a. In one embodiment, near memory is initialized first, followed by far memory. In one embodiment all or a portion of far memory is initialized during operating system boot or OS runtime.

In some embodiments, processor SoC 420 employs an SOC architecture and has a similar configuration to SoC 104 or SoC 104a. In some embodiments, SMC memory 410 in an SCM node 414 is initialized by processor SoC 420 in a manner similar to memory in a platform 400 and/or memory in computer systems 100 and 100a. In some embodiments, firmware running on processor SoC 402 (not separately shown) is used to instruct processor SoC 420 to initiate memory ranges in SMC memory 410.

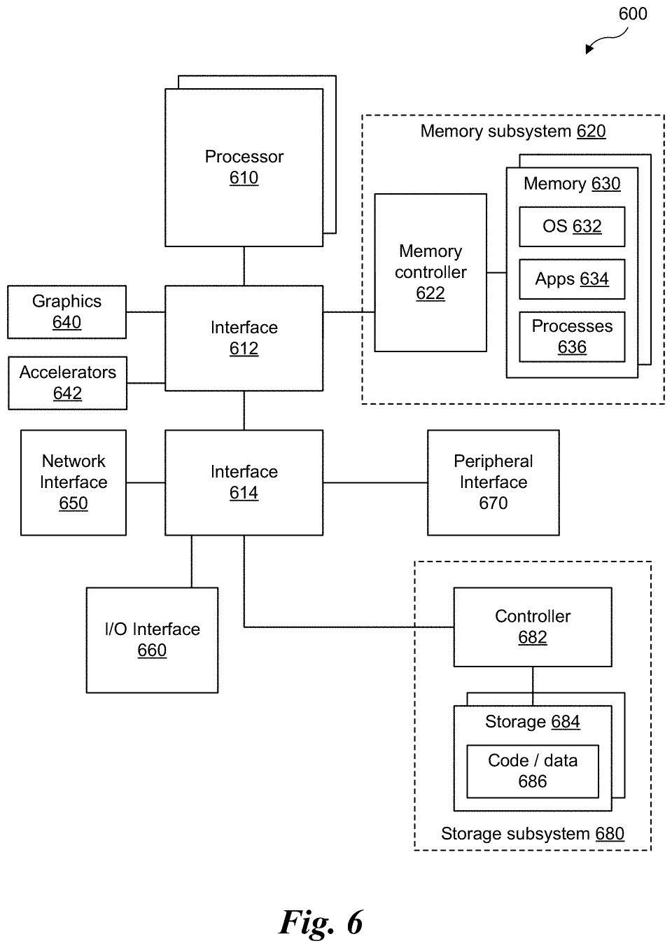

FIG. 6 depicts a system 600 for which aspect of the embodiments described above may be implemented. The system can use embodiments described herein to perform key-value look-up operations for any type of information including packet processing match-action look up operations for received packets. System 600 includes processor 610, which provides processing, operation management, and execution of instructions for system 600. Processor 610 can include any type of microprocessor, central processing unit (CPU), graphics processing unit (GPU), processing core, multi-core processor or other processing hardware to provide processing for system 600, or a combination of processors. Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 600 includes interface 612 coupled to processor 610, which can represent a higher speed interface or a high throughput interface for system components that needs higher bandwidth connections, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a fixed function offload engine that can be accessed or used by a processor 610. For example, an accelerator among accelerators 642 can provide compression (DC) capability, cryptography services such as public key encryption (PKE), cipher, hash/authentication capabilities, decryption, or other capabilities or services. In some embodiments, in addition or alternatively, an accelerator among accelerators 642 provides field select controller capabilities as described herein. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. Various embodiments can be used in connection with network interface 650, processor 610, and memory subsystem 620.

In one example, system 600 includes one or more input/output (I/O) interface(s) 660. I/O interface 660 can include one or more interface components through which a user interacts with system 600 (e.g., audio, alphanumeric, tactile/touch, or other interfacing). Peripheral interface 670 can include any hardware interface not specifically mentioned above. Peripherals refer generally to devices that connect dependently to system 600. A dependent connection is one where system 600 provides the software platform or hardware platform or both on which operation executes, and with which a user interacts.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (i.e., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (i.e., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory is memory whose state (and therefore the data stored in it) is indeterminate if power is interrupted to the device. Dynamic volatile memory requires refreshing the data stored in the device to maintain state. One example of dynamic volatile memory includes DRAM, or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications. The JEDEC standards are available at www.jedec.org.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of system 600. More specifically, power source typically interfaces to one or multiple power supplies in system 600 to provide power to the components of system 600. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 600 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), quick UDP Internet Connections (QUIC), RDMA over Converged Ethernet (RoCE), Peripheral Component Interconnect express (PCIe), Intel® QuickPath Interconnect (QPI), Intel® Ultra Path Interconnect (UPI), Intel® On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof. Data can be copied or stored to virtualized storage nodes using a protocol such as NVMe or NVMe-oF.

In addition to initializing memory using scrubbing engines, the memory initialization schemes disclosed herein provide a security function by clearing stale data and preventing data leaks. As described above, the schemes may also be applied to various memory architectures including tiered memory architecture employ near and far memory and disaggregated memory architectures.

In addition to scrubbing engines in memory controllers and SoCs, future DIMMs may employ built-in scrubbing engines. In these embodiments, an instruction or instructions are sent over the memory channel to the DIMM to instruct the scrubbing engine in the DIMM to initialize memory ranges on the DIMM and/or initialize an entirety of the memory on the DIMM.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Italicized letters, such as ‘m’, ‘n’, ‘q’, ‘x’, etc. in the foregoing detailed description are used to depict an integer number, and the use of a particular letter is not limited to particular embodiments. Moreover, the same letter may be used in separate claims to represent separate integer numbers, or different letters may be used. In addition, use of a particular letter in the detailed description may or may not match the letter used in a claim that pertains to the same subject matter in the detailed description.

As discussed above, various aspects of the embodiments herein may be facilitated by corresponding software and/or firmware components and applications, such as software and/or firmware executed by an embedded processor or the like. Thus, embodiments of this invention may be used as or to support a software program, software modules, firmware, and/or distributed software executed upon some form of processor, processing core or embedded logic a virtual machine running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

Various components referred to above as processes, servers, or tools described herein may be a means for performing the functions described. The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method comprising:
initiating booting of firmware in a computer system including one or more memory devices and a processor System on a Chip (SoC) including a central processing unit (CPU) having a plurality of cores and a memory controller coupled to the one or more memory devices;
in parallel with at least a portion of booting the firmware, initializing a plurality of memory ranges in at least one memory device with at least one scrub engine.

2. The method of claim 1, wherein the at least one scrub engine comprises at least one patrol scrub engine or at least one demand scrub engine.

3. The method of claim 1, wherein the at least one scrub engine includes a plurality of programmable registers or embedded memory, further comprising executing firmware on the CPU to program the plurality of programmable registers or embedded memory with a set of descriptors defining memory ranges to be initialized.

4. The method of claim 1, wherein the plurality of memory ranges are initialized to a known state.

5. The method of claim 1, wherein the firmware is stored on a firmware storage device coupled to the processor SoC and the processor SoC further includes one or more pattern generator and checker (PGC) engines, further comprising:
using a PGC engine to initialize a first region of memory;
loading a portion of firmware into the first region of memory; and
booting the portion of firmware from the first region of memory.

6. The method of claim 5, further comprising:
executing a first portion of firmware from the firmware storage device to program the PGC engine to initialize the first region of memory; and
loading a second portion of firmware into the first region of memory.

7. The method of claim 1, wherein the one or more memory devices comprise a plurality of Dual Inline Memory Modules (DIMMs), further comprising:
employing a plurality of scrub engines to initialize memory regions in the plurality of DIMMs in parallel.

8. The method of claim 1, further comprising:
publishing memory availability information to be accessed by an operating system;
during booting of the operating system, continuing to initialize memory regions; and
updating the memory available information that is published in connection with initializing memory regions.

9. A computer system comprising:
a processor System on a Chip (SoC) including,
a central processing unit (CPU) including a plurality of cores;
a memory controller; and
at least one scrub engine;
a firmware storage device in which firmware is stored, operatively coupled to the processor SoC;
a first Dual Inline Memory Module (DIMM) comprising memory having a first memory space, coupled to the memory controller via a first memory channel;
wherein the computer system is configured to:
initiate booting of firmware stored in the firmware storage device; and
in parallel with at least a portion of booting the firmware, initialize at least a portion of memory in the first DIMM by scrubbing memory associated with at least a portion of the first memory space with at least one scrub engine in the memory controller.

10. The computer system of claim 9, wherein the at least one scrub engine comprises at least one patrol scrub engine or at least one demand scrub engine.

11. The computer system of claim 10, wherein the at least one scrub engine includes a plurality of programmable registers or embedded memory, further configured to:
execute firmware on the CPU to program one or more programmable registers with a set of descriptors defining memory ranges in the first memory space to be initialized or write a data structure containing the set of descriptors in the embedded memory.

12. The computer system of claim 10, wherein the at least one patrol scrub engine or at least one demand scrub engine is embedded in the memory controller.

13. The computer system of claim 9, wherein the processor SoC further includes one or more pattern generator and checker (PGC) engines and is further configured to:
execute a first portion of firmware from the firmware storage device to program the PGC engine to initialize a first region of memory; and
load a second portion of firmware into the first region of memory and execute the second portion of firmware from the first region of memory.

14. The computer system of claim 9, wherein the one or more memory devices comprise a plurality of Dual Inline Memory Modules (DIMMs), wherein the system is further configured to employ a plurality of scrub engines to initialize memory regions in the plurality of DIMMs in parallel.

15. The computer system of claim 9, further configured to:
publish memory availability information to be accessed by an operating system;
during booting of the operating system, continuing to initialize memory regions; and
update the memory available information that is published in connection with initializing memory regions.

16. A processor System on a Chip (SoC) comprising:
a central processing unit (CPU) including a plurality of cores;
a memory controller, including one or more scrub engines and having one or more memory channels to be connected to one or more Dual Inline Memory Modules (DIMMs) via one or more memory buses when the processor SoC is installed in a computer system including the one or more DIMMs and one or more memory buses, the one or more DIMMs including a first DIMM comprising memory having a first memory space, coupled to the memory controller via a first memory channel,
wherein the memory controller is configured to initialize at least a portion of memory in the first DIMM using at least one scrub engine in the memory controller.

17. The processor SoC of claim 16, wherein the at least one scrub engine comprises at least one patrol scrub engine or at least one demand scrub engine.

18. The processor SoC of claim 16, wherein the at least a portion of memory in the first DIMM includes one or more ranges of memory that are initialized to a known state.

19. The processor SoC of claim 16, wherein the at least one scrub engine includes a plurality of programmable registers or embedded memory that are configured to be programmed with a set of descriptors defining memory ranges in the first memory space to be initialized.

20. The processor SoC of claim 16, wherein the one or more DIMMs comprise a plurality of DIMMs, and wherein the memory controller is further configured to employ a plurality of scrub engines to initialize memory regions in the plurality of DIMMs in parallel.
